(19) United States
(12) Patent Application Publication
(10) Pub. No.: US 2017/0243464 A1
(43) Pub. Date: Aug. 24, 2017

(54) MEDICAL ALERT SYSTEM AND THE APPLICATION

(71) Applicant: Alex Diaz, Arizona City, AZ (US)

(72) Inventor: Alex Diaz, Arizona City, AZ (US)

(21) Appl. No.: 15/047,763

(22) Filed: Feb. 19, 2016

(51) Int. Cl. G08B 21/24; H04W 4/00; G08B 25/10

(52) U.S. Cl. CPC G08B 21/24; G08B 25/10; H04W 4/008

(57) ABSTRACT

A system for medical alerts that includes: a wrist band; a display on the wrist band; a software application adapted for use on a smartphone synced with the display; and a plurality of alerts, where the alerts are associated with medical diagnose. The alerts preferably are visually shown on the display and may also be in the form of audio alerts. In one particular embodiment, the alerts relate to prescribed drug dosage and usage. The smartphone syncs with the display via a Bluetooth connection to provide alerts as needed.

### BACKGROUND OF THE INVENTION

Field of Invention

The present invention relates to a medical alert system to provide visual and audio reminders.

Description of Related Art

Many individuals must take various medications on a regular basis due to health and medical conditions. The use of pharmaceutical drugs is quite prevalent and therefore many doctors prescribe medications to treat various ailments and conditions. In certain instances multiple medications may be necessary due to an individual's medical condition. As a result it can be difficult for some individuals to maintain the periodic medical administration requirement associated with various medications. Many medications require periodic dosages taken throughout the day when under use. As a result, it would be advantageous to have a system and a device that could be used to remind and provide alerts for medication dosages.

### SUMMARY OF THE INVENTION

The present invention relates to a system for medical alerts comprising: a wrist band; a display on the wrist band; a software application adapted for use on a smartphone synced with the display; and a plurality of alerts, where the alerts are associated with medical diagnose. The alerts preferably are visually shown on the display and may also be in the form of audio alerts. In one particular embodiment, the alerts relate to prescribed drug dosage and usage. The smartphone syncs with the display via a Bluetooth connection to provide alerts as needed.

### BRIEF DESCRIPTION OF FIGURE

FIG. 1 depicts a medical alert system in accordance with the present invention.

### DETAILED DESCRIPTION

The medical alert system according to the present invention includes a software application that is implemented onto a smart phone or tablet. This medical alert system syncs with a wristband that includes a display and audible alert. The wristband may be worn by a user and therefore programmed to provide alerts related to medication dosages that are required for consumption. Essentially the application installed on the electronic device is programmed by the user to provide alerts associated with various types of medications that the user might consume. These alerts are transmitted to a wristband and display worn by the user. As a result, a user may receive alerts alerting the user of various types of medications that are required for consumption. Further, the alerts may be visual in the form of a visual display provided by the wristband and an audio alert in the form of an audible beep alerting the individual that a dosage is required and a description of the medicine required for consumption.

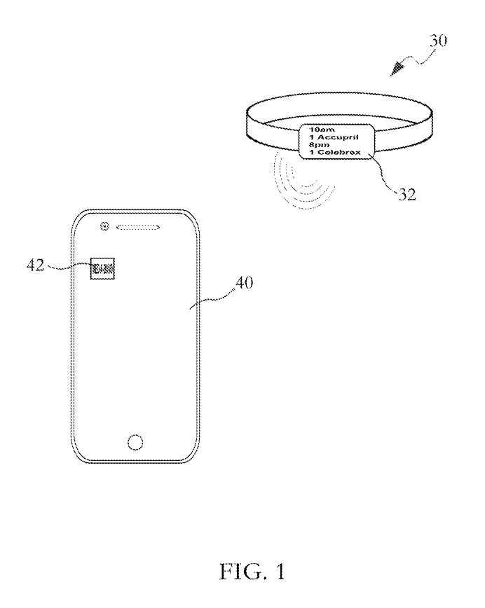

FIG. 1 depicts hardware components associated with the present invention. As shown a Smart Phone 40 includes a Software Application 42 installed on memory of the smart phone 40. This software application 42 may be retrieved through a network connection and installed by the user for use with a Wristband 30. The wristband 30 includes a display 32 along with speakers that emit audible sounds. The display 32 provides a visual display of an alert associated with any prescribed pharmaceutical drug required for consumption by the user. The wristband 30 and display 32 are connected through a Bluetooth connection with the Smart Phone 40 and therefore through use of the software application 42 to monitor and alert a user of pharmaceutical drug dosages and timing. Although depicted in the form of a wristband the present invention may be administered through other wearable jewelry such as a necklace or even an earpiece. The audio alert may be in the form of a beeping noise or even a voice alert alerting the user to the type of medication and the dosage required at a particular time. The instant invention has been shown and described in what it considers to be the most practical and preferred embodiments. It is recognized, however, that departures may be made there from within the scope of the invention and that obvious modifications will occur to a person skilled in the art.

1. A system for medical alerts comprising:
a. a wearable accessory, wherein the wearable accessory includes a necklace or an earpiece, where the necklace or earpiece is adapted for a user;
b. a display on the necklace and a speaker within the earpiece;
c. a software application adapted for use on a smartphone synced with the display and the earpiece; and
d. a plurality of alerts, where the alerts are associated with medical diagnose, wherein the alerts are visually shown on the necklace and the alerts include audio alerts sent to the earpiece.

2. (canceled)

3. (canceled)

4. The system for medical alerts according to claim 1, where the alerts relate to pharmaceutical drug dosages and timing.

5. The system for medical alerts according to claim 1, where the smartphone syncs with the display via a Bluetooth connection.
